(19) United States
(12) Patent Application Publication
(10) Pub. No.: US 2021/0274889 A1
(43) Pub. Date: Sep. 9, 2021

(54) Shoe Last with Screw Joint

(71) Applicants: Samuel Jewell Lochner, Kitchener (CA); Tezera Ketema, Toronto (CA)

(72) Inventors: Samuel Jewell Lochner, Kitchener (CA); Tezera Ketema, Toronto (CA)

(21) Appl. No.: 17/164,987

(22) Filed: Feb. 2, 2021

Related U.S. Application Data
(60) Provisional application No. 62/986,893, filed on Mar. 9, 2020.

(51) Int. Cl. A43D 3/02; B33Y 80/00

(52) U.S. Cl. CPC A43D 3/024; B33Y 80/00

(57) ABSTRACT

A shoe last with a back part and a front part connected by a joint for de-lasting. The joint is operated by the rotation of a threaded component, possibly with a drill. The relative motion of the back and front parts may be restricted to sliding. The shoe last and joint are optimized for 3D printing.

### FIELD OF THE INVENTION

The present invention relates to improvements in shoe lasts used in the manufacture of footwear.

### BACKGROUND

A shoe last is essentially a mold about which footwear can be assembled. Its geometry is a compromise between the shape of a human foot and the intended style of the footwear to be made on it. Unlike a foot, a shoe last is hard, solid, and not flexible. This makes it difficult to remove from assembled footwear (de-lasting). In mass production of footwear, hydraulic presses are sometimes used for de-lasting a one-piece last. But this approach isn't viable for some types of footwear and the necessary equipment is often not available in small scale footwear production. Hence, various systems have been devised to allow the shoe last to take on a shape more conducive to removal from the assembled shoe. In some cases, such systems are said to ‘break’ or ‘open’ the shoe last. The opposite, where the last is returned to its aligned form, sometimes for the purpose of inserting into partially assembled footwear, is to ‘close’ the shoe last.

The simplest such systems consist of strategically made cuts to allow the separation of the shoe last into separate pieces, allowing them to be removed from the shoe individually (screws or pins hold the pieces together during footwear assembly). One example is a straight cut separating the front and back parts of the shoe last. The cut allows the back part of the shoe last to be pulled out of the shoe in a forwards and upwards direction. The difficulty arising from this approach is that the front part of the shoe last remains in the shoe and requires some additional effort to remove. Additionally, some types of footwear require that the shoe last be inserted into a partially assembled shoe, and it is difficult to get the front part fully inserted and then connected to the back part. It is perhaps for this reason a scoop cut is sometimes adopted, where a section is removed from the dorsum of the shoe last. However, with a scoop cut, the main body of the shoe last remains unchanged and is thus difficult to remove from assembled footwear, possibly damaging the footwear.

More complex systems make use of joints, specifically hinges. For instance, there is what is known as an alfa hinge or v-hinge that allows the back part of the shoe last to pivot upwards relative to the front. The difficultly with this system is that the effective length of the shoe last changes minimally and actually increases initially. Thus, considerable force is required for de-lasting which in some cases may damage the footwear. Shoe makers sometimes resort to a simultaneous motion of breaking the joint and removing the footwear.

This problem is solved by what is known as a tendo hinge or telescopic hinge which rotates the back part of the shoe last the opposite direction, thereby immediately shortening the effective length of the shoe last as the shoe last is opened. One disadvantage of this type of shoe last is that the hinge can be accidentally opened when pressure is applied to the bottom of the shoe last when lasting. This is why such stiff springs are used, which perhaps resulted in referring to the opening of a shoe last as ‘breaking’.

Beyond difficulties removing, re-inserting, and lasting, another drawback of existing shoe last joint systems is that they lend themselves most to being made with subtractive manufacturing methods, where material is removed on various machines to shape the shoe last, cut it into pieces, cut the regions for hinges and their attachment points, cut various other features, and insert the required hardware. The processes result in wasted material, require considerable space to complete, and are laborious. The consequence is that shoe lasts are typically only produced in high volume in low cost labor markets and shipped from overseas. This increases the cost, adds to lead times, and creates a barrier for customization.

### BRIEF SUMMARY OF THE INVENTION

The invention is a shoe last with back and front parts connected by a joint that has advantages over existing joints and is optimized for 3D printing. The joint is opened and closed by the rotation of a threaded component. Rotation may be achieved with a drill or other rotating tool. The relative motion of the parts may be restricted by a sliding, hinge, or other joint. The advantage of using a threaded component to control the opening and closing of a shoe last joint is that it can be smoothly and gradually operated when removing the shoe last from assembled footwear (de-lasting) or inserting it into partially assembled footwear. The smooth and gradual movement ensures ease of use by a shoe maker and minimal force applied to the footwear which is particularly important for some stiffer types of footwear. Another advantage is that the joint cannot be accidentally opened when pressure is applied to the bottom of the shoe last. The joint does take additional time to operate compared to conventional shoe last joints, but this is inconsequential for small scale footwear production. The invention is optimized for manufacture by 3D printing. This presents a possibility for a high degree of automation, low cost, on-location manufacturing, and customization.

### BRIEF DESCRIPTION OF THE DRAWINGS

FIG. 1 shows a view of the open shoe last with the sliding joint extended and how a rotating tool may be used to operate the joint.

FIG. 2 is a sectional view taken along lines 11-11 of FIG. 1 showing the closed shoe last with sliding joint retracted.

FIG. 3 is a sectional view taken along lines 11-11 of FIG. 1 showing the open shoe last with sliding joint extended.

FIG. 4 shows a view of the shoe last and rail for the sliding joint when oriented for 3D printing.

### DETAILED DESCRIPTION OF THE INVENTION

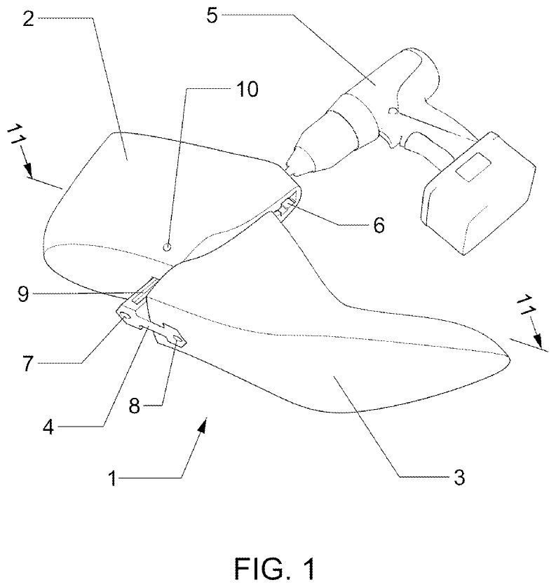

In the invention, the shoe last 1 is split into a back part 2 and a front part 3 (FIG. 1). The opening of the shoe last is achieved by the rotation of a threaded component. Additionally, rotation in the other direction may cause the closing of the shoe last. In this context, a threaded component is any component with a helical structure that may be used to convert rotational motion into translation motion. The threaded component may be rotated by a rotating tool such as a cordless drill 5.

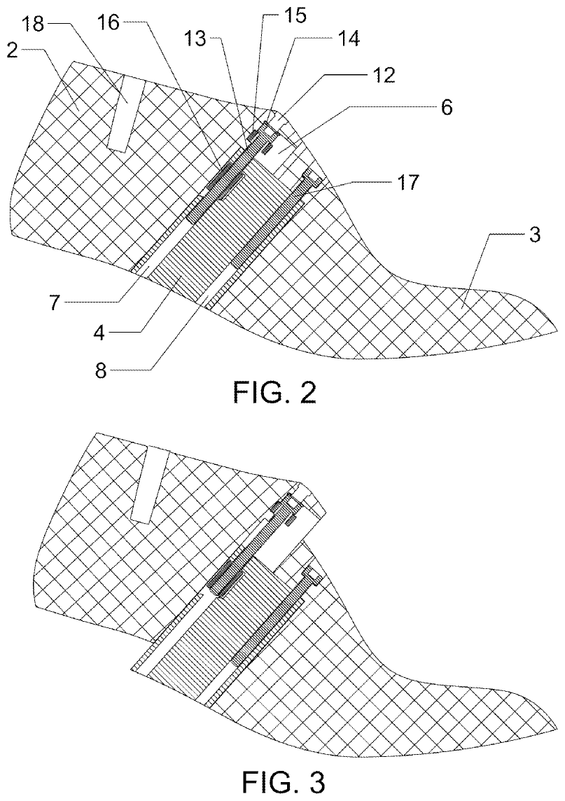

The threaded component that controls the opening and closing of the joint may be male and mate with a gear rack to form a worm rack drive. More preferably, the threaded component mates with a threaded component of opposite gender as in a screw joint. The screw joint may control the angle of the back and front parts about a hinge joint to open and close the shoe last. More preferably, the screw joint may control the relative position of the back and front parts along a sliding axis. The sliding axis may be oriented such that the back part of the shoe last moves forwards (from heel to toe) and upwards (from heel sole to ankle) relative to the front part (FIG. 2, 3) or the front part moves backwards (from toe to heel) and upwards (from heel sole to ankle) relative to the back part. Either way, the effective length of the shoe last is shortened, making it easier to remove the shoe last from assembled footwear. The paths may be reversed for inserting a shoe last into partially assembled footwear.

In addition to the interactions between a male threaded component and a female threaded component, a screw joint requires additional restrictions in order to convert rotational motion to translational motion. Most essentially, one of the two genders must be prevented from rotating. In the current invention, this may be achieved in any way including the contact between the adjacent faces of the back and front parts of the shoe last. Alternatively, a separate sliding joint may approximately restrict all degrees of freedom except for sliding in a direction parallel to the axis of the threaded component. The word approximately is used to convey an understanding there may be some laxity in the joint so as not to inhibit translation.

In the instance of a screw joint, there is a male threaded component such as a socket head cap screw 13 and a female threaded region or component such as a coupling nut 16. The male threaded component may translate with the back part of the shoe last during sliding while the female threaded component translates with the front part of the shoe last or vice versa. The male threaded component may rotate relative to its respective shoe last part while the female threaded component is restrained from rotation relative to its respective shoe last part or vice versa. In one instance of such permutations, the female threaded component is fully constrained relative to the front part of the shoe last while the male threaded component is approximately constrained in all degrees of freedom relative to the back part of the shoe last except rotation about the sliding axis, and as the screw rotates, the sliding action is achieved.

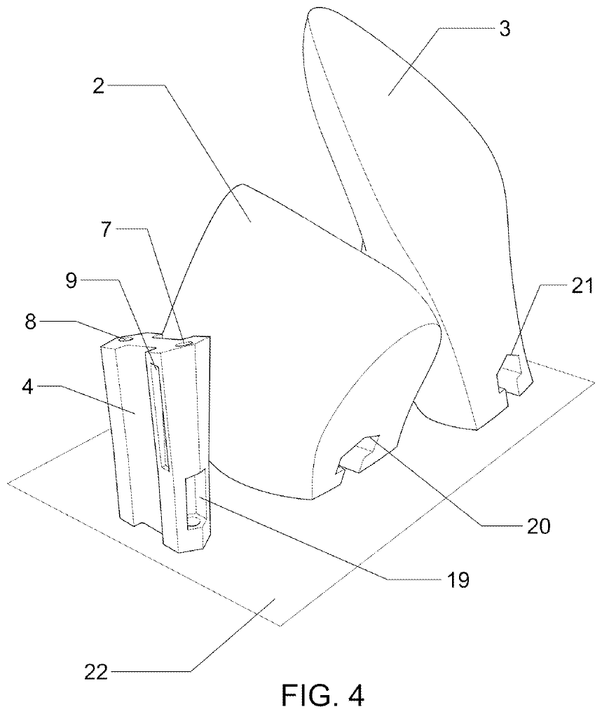

A sliding joint may consist of interlocking regions between the back and front parts of the shoe last. The interlocking regions may taper such that the sliding joint is tight when it is fully retracted (shoe last is in the closed position) but otherwise looser to facilitate smoother actuation of the joint. The interlocking regions may belong to the same material body as the front and/or back parts of the shoe last or be one or more separate parts that are later affixed to the front and/or back parts of the shoe last. In one instance of such permutations, the front and back parts of the shoe last are manufactured with female receiving regions for a rail 4 that is manufactured separately (FIG. 4). One side of the rail is securely fastened to the front part of the shoe last while the back part of the rail forms a sliding surface for the female region on the back part of the shoe last to slide along.

The sliding joint may be constructed in various ways. In one instance, translation of the screw may be prevented by material below and above its head which may be part of the shoe last or added in (FIG. 2, 3). Separate fasteners 15 (possibly a square washer) and 14 (possibly a lock washer which also will not rotate) may be used to reduce wear. The screw head is accessible by a hole 12. A cavity 6 is left such that the screw can be inserted from the joint face (FIG. 1). Alternatively, the screw could be inserted from the top and then held in by a plug. A cavity in the rail may be left to receive the nut 19 (FIG. 4). Threaded or through holes 7, 8 may be left to receive the moving screw 13 and the stationary screw 17. A screw may be inserted into a hole 10 in the side of the last which penetrates into a slot 9 in the rail guide. This slot in the guide rail ends prior to the top and/or bottom of the guide rail 4 such that the screw butts up against the end when the joint is extended, preventing the back and front shoe last parts from being disengaged accidentally.

The shoe last and possibly the sliding joint may be constructed from multiple layers of materials as is the case in 3D printing (layers are added up one after another) rather than subtractive technologies. More specifically, the shoe last and possibly the sliding joint may be constructed from multiple layers of filament as is the case in fused deposition modeling. Any material may be used including polyethylene terephthalate glycol. The color used may be selected to match the intended type of footwear for the shoe last. For example, red may be used for women's shoe lasts, blue for men's shoe lasts, and green for infant's shoe lasts. The shoe last may have a solid or semi-solid interior. Solid walls of any thickness may be used to increase the strength of the shoe last and to create a nail bed that is useful for receiving nails during some lasting processes (shoe materials are held in place by the nails).

A thimble hole 18 may be left near the back of the shoe last during the manufacturing process (FIG. 2). This hole is used at various stages in the footwear assembly process including removing the shoe last from the shoe. Other common features of shoe lasts may also be included, such as a slot for sandal thongs and a hole at the upper back for removing boot lasts with hangers.

The shoe last and possible sliding joint may be designed to address the limitations of 3D printing technologies such as fused deposition modeling. Specifically, overhangs beyond approximately sixty degrees are minimized unless bridging is possible such that the need for support material can be minimized or eliminated. In one instance, the sliding joint faces are designed as planar surfaces such that the front and back parts may be manufactured with the sliding joint surfaces being coplanar with the build plate plane 22 and both the heel and the toe point upwards (FIG. 4). The guide rail may be manufactured as a separate component oriented vertically. The cross sectional shape of the rail may be optimized to avoid large overhangs in the female receiving regions 20, 21.

The shoe last itself may be of a standard size or a custom design for a particular foot. The invention may be a digital representation of a physical object such that it can be sent to another location for 3D printing. The digital representation may be a description of the surfaces or vertices and faces of a mesh stored in any file format including stl, obj, vrml, stp, and iges. Alternatively, the digital representation may be a set of instructions for 3D printing the invention stored in any file format including G-code.

1. A shoe last comprising:
a back part;
a front part;
a threaded component wherein rotation of the threaded component causes the shoe last to open.

2. A shoe last as in claim 1 wherein rotation of the threaded component in the other direction causes the shoe last to close.

3. A shoe last as in claim 1 further comprising an additional threaded component of opposite gender of the threaded component that mates with the threaded component to, along with some means of restricting rotation of one threaded component, form a screw joint that controls the relative position of the back and front parts.

4. A shoe last as in claim 1 further comprising a sliding joint connecting the back and front parts wherein the relative position of the back and front parts along the direction of sliding of the sliding joint is controlled by rotation of the threaded component.

5. A shoe last as in claim 1 further comprising a gear rack component that mates with the threaded component to form a worm rack drive and the worm rack drive controls the opening of the shoe last.

6. A shoe last as in claim 1 further comprising a hinge joint connecting the back and front parts wherein the relative rotation of the back and front parts about the hinge joint is controlled by rotation of the threaded component.

7. A shoe last as in claim 1 wherein the axis of the threaded component is oriented such that the back part translates forwards and upwards when the shoe last opens.

8. A shoe last as in claim 1 wherein the axis of the threaded component is oriented such that the front part translates backwards and upwards when the shoe last opens.

9. A shoe last as in claim 1 wherein rotation of the threaded component can be achieved with a rotating tool.

10. A shoe last as in claim 4 wherein the sliding joint is formed by interlocking regions between the back and front parts.

11. A shoe last as in claim 10 wherein the interlocking regions taper such that the connection between the back and front parts is loose to facilitate sliding and becomes tight when the sliding joint is fully retracted.

12. A shoe last as in claim 10 wherein the interlocking regions are established with at least one additional manufactured body.

13. A shoe last as in claim 4 with a mechanical limitation on the range of sliding of the sliding joint such that the back and front parts cannot be accidentally disengaged from the sliding joint.

14. A shoe last as in claim 1 constructed from multiple layers of material as is the case of 3D printed objects.

15. A shoe last as in claim 14 wherein the layers are parallel to the plane of sliding of the sliding joint.

16. A shoe last as in claim 14 further comprising features of finished shoe lasts including a thimble hole.

17. A shoe last as in claim 14 that is partially hollow.

18. A shoe last as in claim 14 wherein the geometry has been optimized for 3D printing without support material by minimizing non-bridgeable overhangs beyond approximately sixty degrees with the build plate normal vector when the adjacent faces of the back and front parts that form the sliding surface of the sliding joint are coplanar with the build plate plane and heel and toe point upwards.

19. A shoe last as in claim 1 wherein the shoe last is custom to suite a particular foot.

20. A shoe last as in claim 1 wherein the back and front parts are digital representations of physical objects.
